(19) United States
(12) Patent Application Publication
(10) Pub. No.: US 2012/0061527 A1
(43) Pub. Date: Mar. 15, 2012

(54) SUSPENSION ELEMENT OF A TRAILING CABLE ASSEMBLY

(75) Inventors: Gerd Spies, Herdecke (DE); Stefan Fitzler, Iserlohn (DE); Sven Muller, Breckerfeld (DE)

(73) Assignee: DEMAG CRANES & COMPONENTS GMBH, Wetter (DE)

(21) Appl. No.: 13/318,959

(22) PCT Filed: Apr. 27, 2010
(86) PCT No.: PCT/EP2010/055645

§ 371 Date: Nov. 4, 2011

(30) Foreign Application Priority Data
May 6, 2009 (DE) 10 2009 020 096.7

(51) Int. Cl. F16L 3/16

(52) U.S. Cl. 248/58

(57) ABSTRACT

The invention relates to trailing cable assembly including a hollow-profile rail that is open over a longitudinal gap and a plurality of suspension elements, which can be moved along the rail and to which an electrical power line may be fastened. In order to create such an assembly in which the suspension elements can be easily mounted and replaced, the suspension elements include support parts that can be introduced into a hollow space of the rail from the outside by way of the longitudinal gap to be in a mounting position, and the support part can be moved out of the mounting position and into a operating position in which it bridges the longitudinal gap of the rail.

### BACKGROUND OF THE INVENTION

The present invention relates to suspension devices for use with hollow-profile rails, wherein the suspension devices can be moved along the rail.

The German-language prospectus of the company Demag Cranes & Components GmbH, Wetter, Germany, with the title “Demag-KBK 25-System” (version: February 2007), describes for example power supply units with trailing cables for trolleys, cranes, monorails, and loading and processing machinery. Such trailing cables are used, besides so-called contact lines, when movable electrical consumers such as crane crabs with an electrical traversing drive and with an electrical lifting drive have to be supplied with electrical energy. The contact line is usually fashioned as a flat cable with several electrical wires and hung by several suspension elements in the manner of a garland from a C-shaped rail that is open at the bottom. The suspension elements can move along the rail, so that the trailing cable can follow the movable electrical consumer. For this, the suspension elements have a traversing gear with four rollers, that can travel inside the C-shaped rail. In the assembly process, the traversing gears are shoved into the rail from one of the ends of the rail. The ends of the rail are then closed by fixed closure elements, such as caps. A holding part projecting downwardly from the rail is suspended from the traversing gear. The holding part has a bearing element with cross section of a circle segment, on which the flat cable is laid, protected against kinks. In addition, a fixation element such as a screw or snap connection is placed on the bearing element from above in order to secure the flat cable on the bearing element. The bearing element is suspended from the traversing gear by a bracket. For the assembly, the flat cable is threaded in from one end through the brackets of the holding elements of the suspension elements arranged in series along the rail and then secured by the fixation elements.

From German application DE 100 09 245 A1 there is already known a cable truck for a trailing cable, whose holding part is configured such that the trailing cable can be installed and removed sideways, that is, transverse to the direction of travel of the cable truck. This makes it possible to connect the cable truck to a rail of a power supply system even before the trailing cable is fastened to the cable truck.

A comparable cable truck is described in the German application DE 34 09 628 A1. Here, the holding part for the trailing cable is configured as a plastic loop, which is fastened to the cable truck by a snap connection. In addition, a clamp fitting is provided, which further secures the trailing cable inside the loop.

Moreover, another suspension element for a trailing cable is known from the German utility model patent DE 1 931 764 U, which is not configured as a traversing gear with four rollers, but instead as a mushroom-headed or piston-shaped sliding block of thermoplastic or duroplastic material.

### SUMMARY OF THE INVENTION

The present invention provides suspension elements that are compatible for use with a hollow-profile rail that is open over a longitudinal gap. The suspension elements can be moved along the rail and can have an electrical power line fastened thereto. The suspension elements can be easily mounted and replaced along the rail.

According to one aspect of the invention, a suspension layout includes a hollow-profile rail that is open over a longitudinal gap and with a plurality of suspension elements that can be moved along the rail and to which an electrical power line is fastened, and easy mounting and an easy replacement of the suspension elements may be achieved in that the suspension elements for a fastening to the rail are configured such that a support part of these can be introduced from the outside via the longitudinal gap into a hollow space of the rail in a mounting position. After moving from the mounting position to an operating position the support part bridges the longitudinal gap and the support part is T-shaped in the operating position and looking in the longitudinal direction of the rail, and it has a stem part sticking out from the rail and a sliding part resting in the rail, being fastened to the stem part in the central region. Thus, the suspension elements of the invention can be easily introduced into the longitudinal gap of the open rail. This is possible at any place on the rail. It is not necessary to introduce the suspension elements into the rail at its start or end. This facilitates a mounting and a replacement of the suspension elements. For example, a replacement of the suspension elements when using the layout of the invention will occur in the foundry, where the harsh environment leads to increased wear on the suspension elements. It is now also easy to replace individual suspension elements, especially those located between other suspension elements. The T-shape makes possible a secure engaging behind the rail in its hollow space.

The suspension elements of the invention are especially suited to use in connection with overhead conveyors, such as industrial bay cranes, traveling cranes and bridge cranes, during the operation of which the suspension elements are moved along the rail together with the power cable hanging from them.

It is structurally advantageous for the stem part to be cylindrical.

In one aspect, the sliding part is configured as a cuboid and rigidly joined to the stem part.

In the operating position of the suspension element according to this aspect, a secure locking is achieved in that at least one locking element is arranged on each of the stem parts, being supported on the rail and preventing the support part from moving from the operating position into the mounting position.

Furthermore, advantageously the locking element is shaped as an arm and it is resilient, and projects into the longitudinal gap of the rail in the operating position.

The safety of the fastening of these suspension elements in the rail is further increased in that two locking elements are arranged in redundant fashion on each suspension element.

In an advantageous design, the locking element is fastened in the region of the end of the stem part away from the sliding part, it is inclined in the direction of the longitudinal gap as seen from the operating position of the suspension element, and it tapers starting from the stem part. Thanks to the tapering shape, the locking element becomes elastically resilient and this facilitates a movement into the longitudinal gap. The inclined orientation facilitates the locking element's engaging with the rail to perform its function, in particular, it can extend into its longitudinal gap.

In another aspect, the sliding part is arranged able to tilt about an axle at the end of the stem part away from the holding part and the axle is oriented transversely to the longitudinal dimension of the stem part. Thus, in the mounting position, the sliding part can be folded parallel to the stem part and then be introduced through the longitudinal gap into the rail. After this, the sliding part folds into a position at right angles to the stem part and thus can no longer move out from the longitudinal gap in this operating position. In the event that the longitudinal gap of the rail is open at the bottom, the stem part is held in the operating position by gravity.

In yet another aspect, the sliding part is shaped as a plate.

In still another aspect, the suspension element includes a holding part, in addition to the support part, from which the power cable is hung. Thus, the functions of fastening of the suspension element to the rail and fastening the power cable to the suspension element are separated from each other and the respective support part and holding part can be specially adapted to these functions.

Since the holding part has an elongated receiving element that is partly passed around the power cable, which is fastened at one end by a connection element to the support part and its other end can be connected by a closure element to the holding part after the power cable is inserted, the power cable can be secured by the holding part of the suspension element at any given site along the rail or be removed for a replacement of the power cable or the suspension element. Since the power cable is inserted from the side into the holding part onto the receiving element and then secured by the closure element, the power cable does not need to be laboriously threaded by its starting piece into the first and all succeeding holding parts.

The power cable is held securely by the holding part, since the connection element is configured in the nature of a wheel well open at one end with an opening and the closure element is configured as a cover that closes the opening. Thus, the power cable in a hanging suspension element is securely held in a downwardly open U-shaped space that is bounded at the bottom by the bearing element and at the sides and top by the connection element and the closure element.

According to another aspect, the power cable is configured as a flat cable with several electrical wires. In this way, the power cable can be fastened, without suffering damage, in the manner of a garland at the plurality of suspension elements arranged along the rail. In the area of the bearing elements the power cable is deflected by around 180° and is thus less subjected to kinks by the use of a flat cable.

It is especially advantageous that the rail has a hollow space broadening out from the longitudinal gap and a C-shaped cross section and its longitudinal gap points downwards. Thanks to this configuration of the rail, the simple fastening of the suspension elements with the T-shaped support part is made possible. The bearing surfaces for the sliding part of the support part are provided by the shape of the rail in the hollow space of the rail.

The suspension element can be produced especially easily as an injected molded plastic part, for example.

These and other objects, advantages and features of this invention will become apparent upon review of the following specification in conjunction with the drawings.

### BRIEF DESCRIPTION OF THE DRAWINGS

FIG. 1 is a side elevation of a trailing cable layout with a rail, a power cable, and a plurality of suspension elements in accordance with the present invention;

FIG. 2 is a perspective view of one of the suspension elements of FIG. 1, shown with an opened or uncovered holding part;

FIG. 3 is another perspective view of the suspension element of FIG. 2, shown with a closed holding part;

FIG. 4 is a sectional end elevation of a rail supporting a suspension element in a mounting position;

FIG. 5 is another sectional end elevation of the rail and suspension element, shown in an operating position;

FIG. 6 is a side elevation of the rail and suspension element of FIG. 5;

FIG. 7 is a perspective view of an alternative suspension element shown with an opened or uncovered holding part;

FIG. 8 is a sectional end elevation of a rail with the suspension element shown in a mounting position; and

FIG. 9 is another sectional end elevation of the rail and suspension element of FIG. 7, shown with the suspension element in an operating position.

### DESCRIPTION OF THE PREFERRED EMBODIMENTS

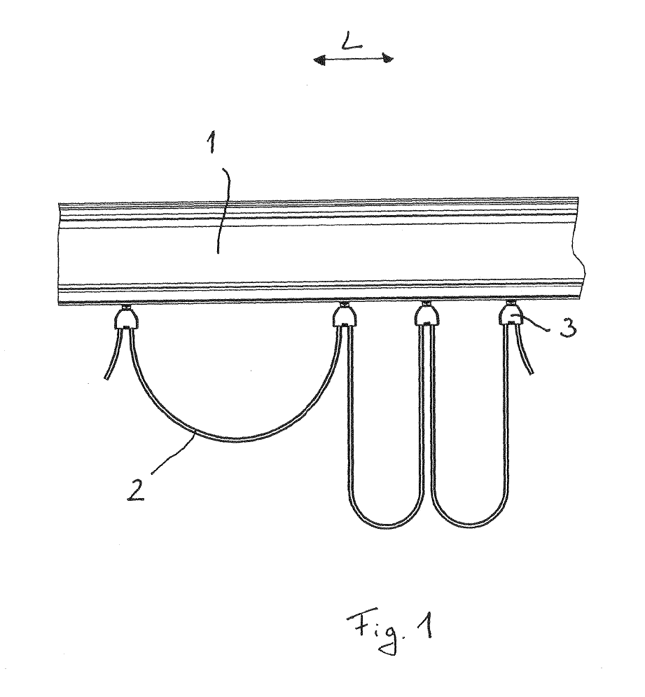

Referring now to the drawings and the illustrative embodiments depicted therein, a trailing cable assembly (FIG. 1) is provided for use when movable electrical consumers such as crane crabs with an electric lift drive have to be supplied with electric power. Other areas of use for such trailing cable assemblies are cranes, suspended monorail tracks, and loading and processing machinery. This trailing cable assembly includes a rail 1, from which a power cable 2 is suspended via a plurality of suspension elements 3 in the nature of a garland. The suspension elements 3 can move along the rail 1 in its lengthwise direction L, in order to bring up the power cable 2 to the movable electrical consumers (not shown). Depending on the position of the electrical consumer relative to the rail 1, the suspension elements 3, of which a plurality are arranged in succession looking in the lengthwise direction L of the rail 1, are moved closer together or further apart, so that the loops of the power cable 2 hanging down become larger or more narrow. The power cable 2 is usually configured as a flat cable with several electrical wires arranged next to each other.

Basically it is also possible to use the above described suspension elements 3 and rail 1 to hang a pneumatic power conduit 2 in the manner of a trailing cable assembly.

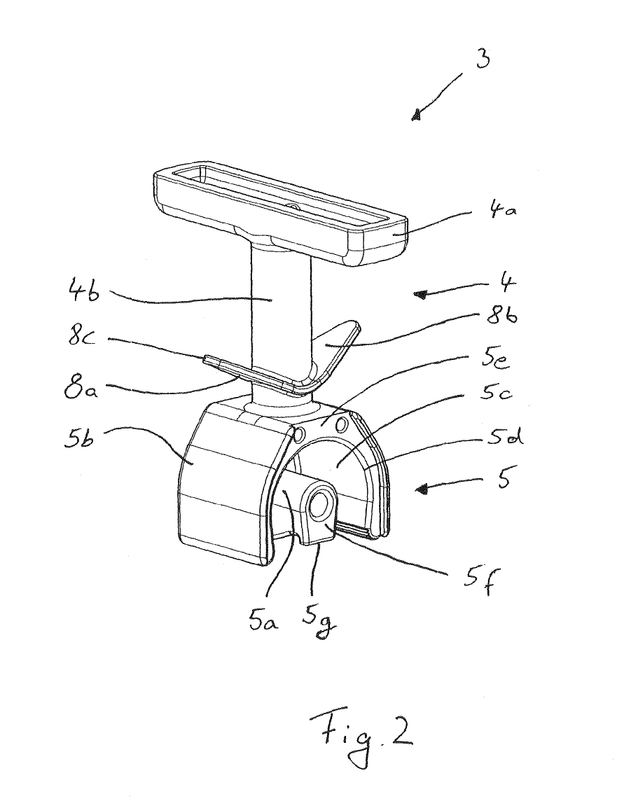

In the illustrated embodiment of FIG. 2, suspension element 3 can be roughly divided into an upper support part 4 and a lower holding part 5 fastened to it or hanging from it. By means of the support part 4, the suspension element 3 is connected to the rail 1. For this, the support part 4 is basically configured in a T-shape with a top cuboid sliding part 4a and a circular pipe-like stem part 4b joined centrally to it. The sliding part 4a is rigidly joined to the stem part 4b. The sliding part 4a has a flat cuboid shape and is open at the top and configured hollow on the whole. By means of the sliding part 4a, the suspension element 3a slides inside the rail 1 to and fro in the lengthwise direction L.

At the lower end of the stem part 4b away from the sliding part 4a is disposed the holding part 5, from which the power cable 2 is hung. The holding part 5 consists basically of a bolt-shaped receiving element 5a, which is fastened to a connection element 5b at its rear end in relation to the view in FIG. 2. The receiving element 5a is oriented horizontally with its lengthwise dimension when the stem part 4b is oriented vertically, and its lengthwise dimension runs parallel with the lengthwise dimension of the sliding part 4a. Because the receiving element 5a is fastened to the connection element 5b only at one end and the connection element 5b is fastened to the lower end of the stem part 4b, and the connection element 5b is configured not merely as a simple vertical web but overall in the nature of a wheel well, an overall U-shaped space 5c is created between the connection element 5b and the receiving element 5a. It should be noted here that the U is upside down. This U-shaped space 5c in the mounting position is open to one side, namely, on the side opposite the end of the receiving element 5a joined to the connection element 5b. This opening 5d of the U-shaped space 5c serves to shove the power cable 2, which may be configured as a flat cable, sideways into the U-shaped space 5c in the form of a loop. The power cable 2 will come to rest on the receiving element 5a, since the suspension element 3 is usually hung by the vertically oriented stem part 4b from a downwardly open and C-shaped rail 1. For reasons of clarity, the loop of the power cable 2 is not shown in FIG. 2.

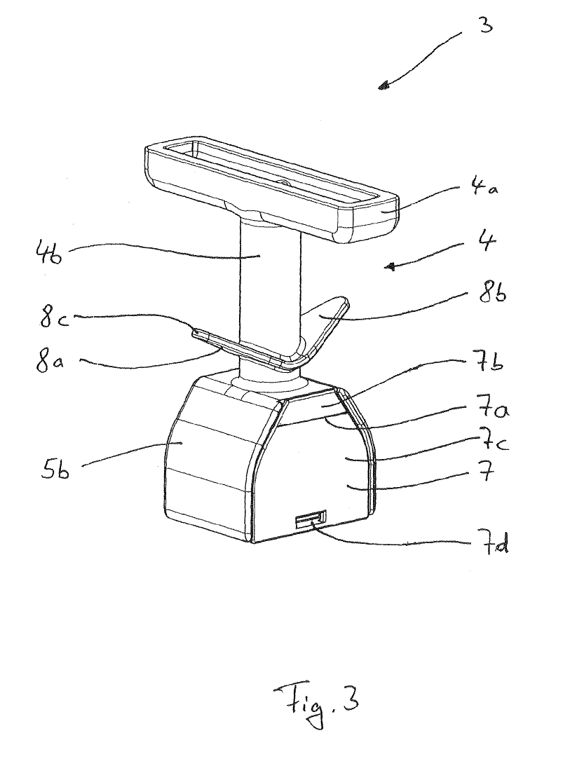

Furthermore, one notices in FIG. 2 that the holding part 5, which overall has a cuboid exterior shape, has two of the upper edges that are opposite each other with flattened or rounded shape. On the side 5e of the holding part 5 where the opening 5d is located, there are two boreholes 6a and 6b arranged in the upper region, which serve to accommodate insert elements of a cover 7 (see FIG. 3). A downwardly oriented shoulder 5g is arranged at the free end 5f, serving as an abutment for a snap closure to close the cover 7, such as shown in FIG. 2.

Moreover, two locking elements 8a, 8b are arranged on the stem part 4b of the suspension element 3 (FIG. 2). The locking elements 8a, 8b have the shape of an elongated equilateral triangle in top view. The vertex 8c of the locking elements 8a, 8b is turned away from the stem part 4b. Also, when the stem part 4b is oriented vertically, the locking elements 8a, 8b are formed not horizontally, but starting at the stem part 4b and rising linearly in the direction of the sliding part 4a. The angle subtended between the stem part 4b and the locking elements 8a, 8b is approximately in the range of about 60° to 80° and is preferably about 70°. Furthermore, the locking elements 8a, 8b arranged opposite in relation to the stem part 4b are oriented with their lengthwise dimension at right angles to the lengthwise dimension of the sliding part 4a.

The suspension element 3 with its support part 4, the holding part 5 and the locking elements 8a, 8b is made as a single plastic injection molded piece.

Referring now to FIG. 3, the U-shaped space 5c of the holding part 5 is closed with a closure element 7 in the form of a cover. In regard to the other components of the suspension element 3 shown. in FIG. 3, reference is made to the preceding description of FIG. 2. In regard to the closure element 7, it will be noticed that a horizontally oriented hinge 7a, which may be a film or “living” hinge or the like, extends in the upper region, dividing the closure element 7 into a narrow upper fixed part 7b and an adjoining lower folding part 7c. The hinge 7a is located approximately in the area of the upper end of the space 5c, so that the complete opening 5d of the space 5c is opened up by an upward folding of the folding part 7c, so that the power cable 2 can be inserted. The fixed part 7b is pressed in via pins (not shown) arranged on the back side and received into the boreholes 6a, 6b (FIG. 2) in the assembly process by a press fitting or a snap connection, and thus is connected sufficiently firmly to the connection element 5b of the holding part 5. Accordingly, the folding part 7c of the closure element 7 can be moved about the hinge 7a from a closed, nearly vertical position into an open, nearly horizontal position. In order to hold the folding part 7c in its closed position, an inwardly pointing and hook-like projection 7d is provided at its lower end, which can enter into a snap connection with the other projection 5g of the receiving element 5a. Thus, the holding part 7 can be opened once again to replace the power cable 2.

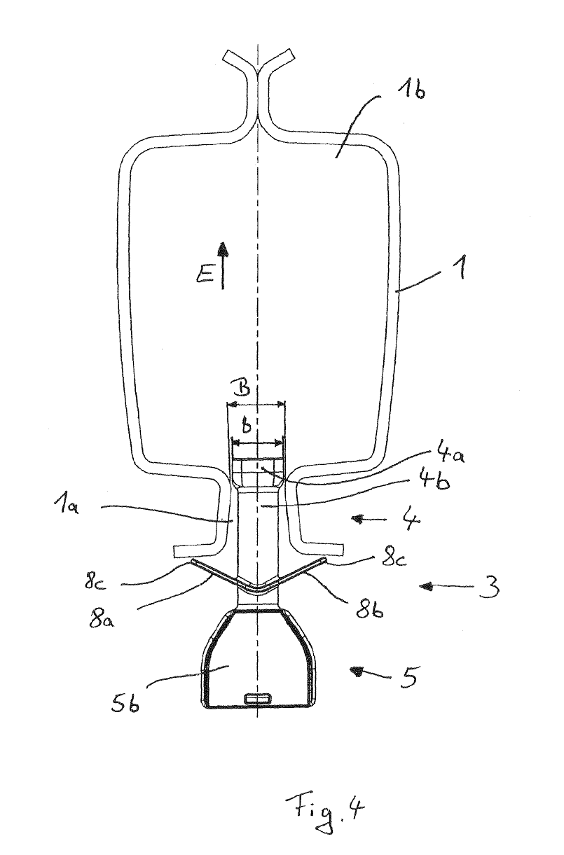

Referring now to FIG. 4, rail 1 is shown with a suspension element 3 in a mounting position. In this mounting position, the sliding part 4a of the suspension element 3 can be led through a longitudinal gap 1a of the overall basically c-shaped rail 1 into its hollow space 1b. For this, the suspension element 3 is oriented so that its sliding part 4a is oriented by its lengthwise dimension in the lengthwise direction L of the rail 1 and thus in the lengthwise direction of the longitudinal gap 1a of the rail 1. The width b of the sliding part 4a is chosen such that it is slightly narrower than the width B of the longitudinal gap 1a of the rail 1. After the sliding part 4a has been inserted so far through the longitudinal gap 1a that it is completely inside the hollow space 1b of the rail 1 adjoining the longitudinal gap 1a and broadening out, the suspension element 3 is turned around 90° about the lengthwise dimension of the stem part 4b, so that now the sliding part 4a extends transversely to the lengthwise dimension L of the rail 1 and thus bridges over the longitudinal gap 1a. This position of the sliding part 4a is also known as the operating position.

Furthermore, the locking elements 8a, 8b in the mounting position do not make contact with the rail 1 (FIG. 4). In another type of rail 1, with the sliding part 4a fully inserted into the longitudinal gap 1a of the rail 1, the two locking elements 8a, 8b already rest against the rail 1 and are already elastically deformed in the direction of the holding part 5. Also, no power cable 2 is inserted into the holding part 5 during the mounting on and dismounting of the suspension element 3 from the rail 1. Basically, it is also possible to leave the power cable 2 in the holding part 5 during a dismounting step.

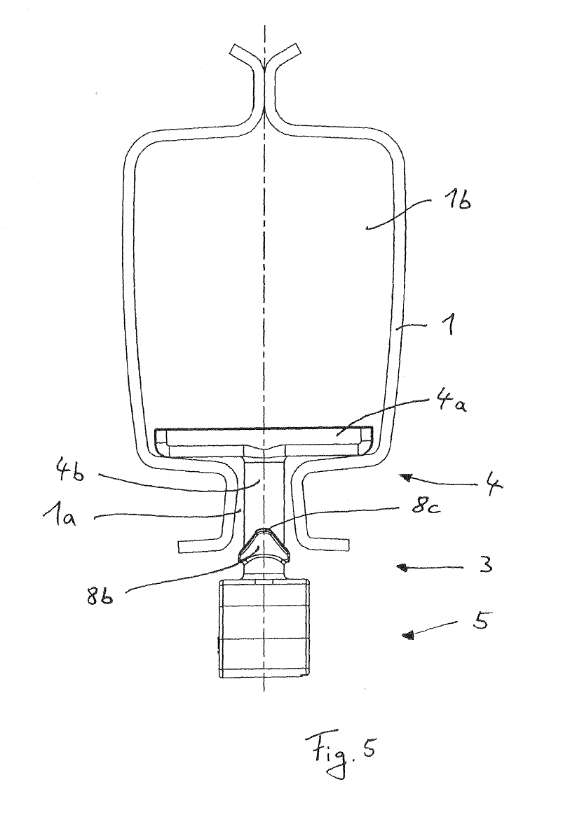

Referring now to FIG. 5, the suspension element 3 is no longer in the mounting position of FIG. 4, but instead in the operating position, where the sliding part 4a of the support part 4 is oriented transversely to the lengthwise direction L of the rail 1. In the operating position shown here, the locking elements 8a, 8b extend at least with their vertices 8c into the longitudinal gap 1a of the rail 1. In this way, the sliding part 4a can be prevented from twisting out of the operating position and into the mounting position, so that is might fall down and out from the longitudinal gap 1a. Moreover, the locking elements 8a, 8b have a guiding function, for during the displacement of the power cable 2 along the rail 1 the sliding part 4a easily turns clockwise or counterclockwise about the longitudinal axis of the stem part 4b from its exact operating position, in which the sliding part 4a is oriented with its lengthwise dimension at right angles to the lengthwise dimension of the longitudinal gap 1a. This turning motion is limited by the locking elements 8a, 8b, since these come to rest against the inner side wall of the longitudinal gap 1a as a result of the turning motion. Since the locking elements 8a, 8b are resilient, they can be elastically bent out from the longitudinal gap 1a for a dismounting of the suspension elements 7. The suspension element 7 can now be freely rotated back from the operating position to the mounting position and the sliding part 4a can be removed downward from the longitudinal slot 1a. However, it is generally preferable to first remove the power cable 2 from the holding part 5. If desired, the power cable 2 can also be left in the holding parts 5.

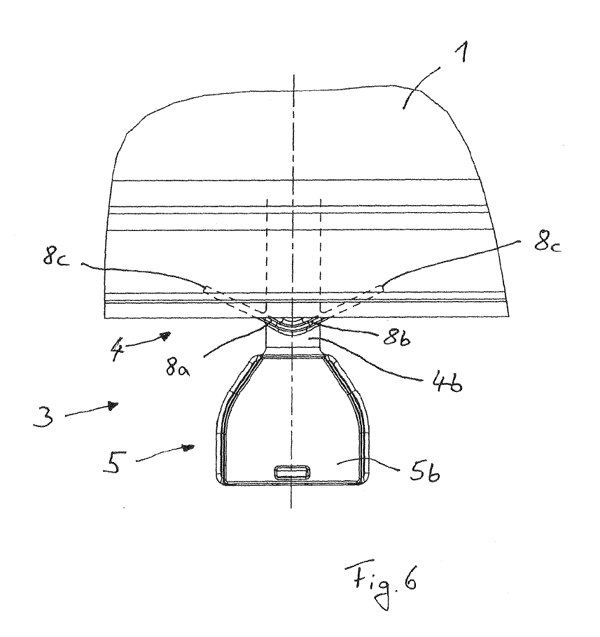

Referring now to FIG. 6, a suspension element 3 is shown in its operating position with the locking elements 8a, 8b extending at least by their vertices 8c into the longitudinal gap 1a of the rail 1. In the illustrated embodiment, the locking elements 8a, 8b extend into the longitudinal gap 1a by around a third of their length.

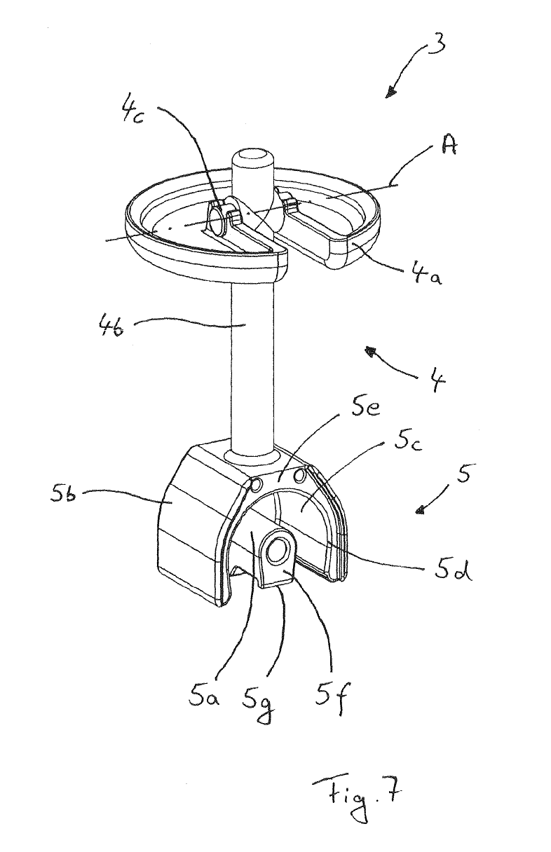

According to an alternative embodiment, and as shown in FIG. 7, a suspension element 3 includes a holding part 5 that is substantially similar to holding part 5 as shown and described above with reference to FIGS. 2 and 3. Here as well, the suspension element 3 has an upper support part 4, besides the lower holding part 5. The support part 4 is basically T-shaped with an upper plate-like sliding part 4a and a centrally joined round pipe stem part 4b. By means of the sliding part 4a, the suspension element 3a slides inside the rail 1 back and forth in the longitudinal direction L. Unlike the suspension element of FIGS. 2-6, the sliding part 4a is not rigidly fastened to the stem part 4b but rather is articulated to the upper end of the stem part 4b, facing away from the support part 5, by a tilting axis 4c with an axle A that is oriented at right angles to the lengthwise dimension of the stem part 4b. Thus, the sliding part 4a can be oriented transversely and parallel to the lengthwise dimension of the stem part 4b. In FIG. 7, sliding part 4a is shown in the operating position, oriented at right angles to the lengthwise dimension of the stem part 4b.

The suspension element 3 may also be made with its support part 4 and the holding part 5 as a single piece of injection molded plastic, such as shown in FIG. 7.

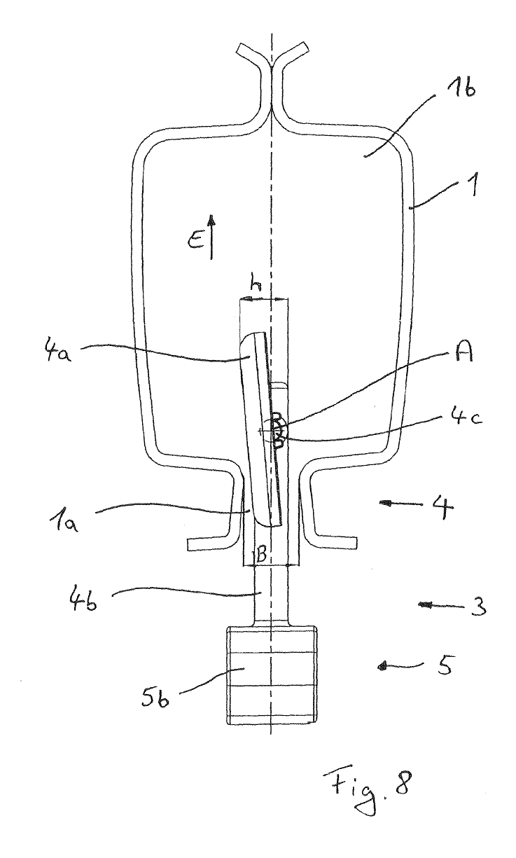

When suspension element 3 is in the mounting position of FIG. 8, the sliding part 4a of the suspension element 3 can be led through a longitudinal gap 1a of the overall basically c-shaped rail 1 into its hollow space 1b. For this, the suspension element 3 is oriented so that its sliding part 4a is oriented by its lengthwise dimension in the lengthwise direction L of the rail 1 and thus in the lengthwise direction of the longitudinal gap 1a of the rail 1, and also at the same parallel to the lengthwise dimension of the stem part 4b. This is possible, since the sliding part 4a can tilt about the axle A of the stem part 4b. The dimension h, which consists of a height of the sliding part 4a and a proportionate width of the stem part 4b, is chosen such that it is slightly narrower than the width B of the longitudinal gap 1a of the rail 1. After the sliding part 4a has been inserted so far through the longitudinal gap 1a that it is completely inside the hollow space 1b of the rail 1 adjoining the longitudinal gap 1a and broadening out, it is tilted by the force of gravity into the operating position, since on the one hand the tilt axis 4c moves easily and on the other hand the sliding part 4a in the mounting position and when vertically oriented is heavier on top than on the bottom in relation to the tilt axis 4c. The tilting motion can also be produced by tilting force applied by a tool or by the finger of the person installing it. In the operating position, the sliding part 4a thus extends transversely to the lengthwise dimension L of the rail 1 and thus bridges over the longitudinal gap 1a.

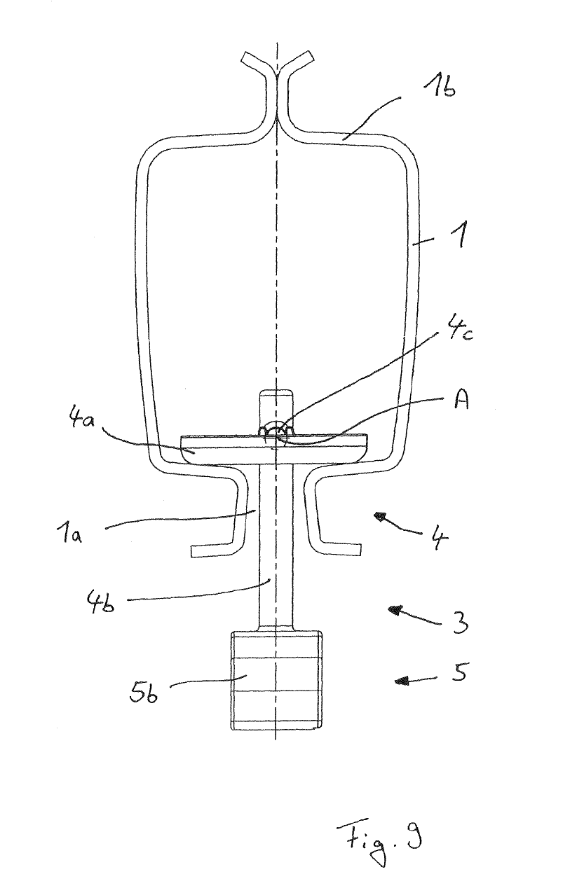

Referring now to FIG. 9, the suspension element 3 is no longer in the mounting position, as shown in FIG. 8, but instead in the operating position, where the sliding part 4a of the support part 4 is oriented transversely to the lengthwise direction L of the rail 1. Since the sliding part 4a has a round cross section, the sliding part 4a can easily turn clockwise or counterclockwise about the lengthwise axis of the stem part 4b from its exact operating position, in which the tilt axis 4c is oriented with its lengthwise dimension parallel to the lengthwise dimension of the longitudinal gap 1a, as the power cable 2 moves along the rail 1, without the danger of the plate-like sliding part 4a falling downward from the longitudinal gap 1a. For a dismounting, the sliding part 4a is positioned with a rod-shaped tool or with the finger of the installing person through the longitudinal gap 1a and then removed downward from the longitudinal slot 1a. However, it is generally preferable to first remove the power cable 2 from the holding part 5. If desired, the power cable 2 can also be left in the holding parts 5.

Changes and modifications to the specifically described embodiments may be carried out without departing from the principles of the present invention, which is intended to be limited only by the scope of the appended claims as interpreted according to the principles of patent law including the doctrine of equivalents.

1. A trailing cable assembly comprising:
a hollow-profile rail that defines a hollow space which is open along a longitudinal gap;
a plurality of suspension elements that are movable along the rail and configured to have an electrical power line fastened thereto, each of the suspension elements including a support part that can be introduced to the hollow space of the rail from the outside via the longitudinal gap in a mounting position, and the support part being movable from the mounting position to an operating position in which the support part bridges the longitudinal gap of the rail; and
wherein the support parts are generally T-shaped in the operating position when viewed in the longitudinal direction of the rail, and each support part includes (i) a sliding part resting in the rail and (ii) a stem part extending outwardly from the rail, the stem part being fastened to a central region of the sliding part.

2. The trailing cable assembly according to claim 1, wherein the stem part is cylindrical.

3. The trailing cable assembly according to claim 1, wherein the sliding part is configured as a cuboid and is rigidly joined to the stem part.

4. The trailing cable assembly according to claim 3, further comprising at least one locking element is arranged on each of the stem parts, the locking element being supported on the rail and configured to prevent the support part from moving from the operating position into the mounting position.

5. The trailing cable assembly according to claim 4, wherein the locking element is a resilient member that is shaped as an arm and that projects into the longitudinal gap of the rail in the operating position.

6. The trailing cable assembly according to claim 4, wherein two of the locking elements are arranged on each suspension element.

7. The trailing cable assembly according to claim 4, wherein the locking element is coupled to an end region of the stem part, away from the sliding part, and is inclined in the direction of the longitudinal gap as viewed from the operating position of the suspension element, and wherein the locking element tapers starting from the stem part.

8. The trailing cable assembly according to claim 1, further comprising an axle at an end region of the stem part and oriented transversely to the longitudinal dimension of the stem part, and wherein the sliding part is configured to tilt about the axle in a direction that is away from the holding part.

9. The trailing cable assembly according to claim 8, wherein the sliding part is shaped as a plate.

10. The trailing cable assembly according to claim 1, wherein the suspension element comprises a holding part coupled to the support part and configured for supporting the electrical power cable.

11. The trailing cable assembly according to claim 10, wherein the holding part includes an elongated receiving element coupled at one end thereof to a connection element, the receiving element configured to be partly passed around by the power cable and the connection element coupling the holding part to the support part, wherein one end of the connection element is configured to receive a closure element after the power cable is passed around the receiving element.

12. The trailing cable assembly according to claim 11, wherein the connection element is configured in the nature of a wheel well that forms an opening at one end of the connection element, opposite where the elongated receiving element is coupled to the connection element, and wherein the closure element is configured as a cover that closes the opening of the connection element.

13. The trailing cable assembly according to claim 1, wherein the power cable is configured as a flat cable with a plurality of electrical wires.

14. The trailing cable assembly according to claim 1, wherein the rail comprises a generally C-shaped cross section with the longitudinal gap pointing downwards and the hollow space of the rail broadening out from the longitudinal gap.

15. The trailing cable assembly according to wherein the suspension element is comprises an injection-molded plastic part.

16. The trailing cable assembly according to claim 2, wherein the sliding part is configured as a cuboid and is rigidly joined to the stem part.

17. The trailing cable assembly according to claim 5, wherein two of the locking elements are arranged on each suspension element.

18. The trailing cable assembly according to claim 17, wherein the locking element is coupled to an end region of the stem part, away from the sliding part, and is inclined in the direction of the longitudinal gap as viewed from the operating position of the suspension element, and wherein the locking element tapers starting from the stem part.

19. The trailing cable assembly according to claim 5, wherein the locking element is coupled to an end region of the stem part, away from the sliding part, and is inclined in the direction of the longitudinal gap as viewed from the operating position of the suspension element, and wherein the locking element tapers starting from the stem part.

20. The trailing cable assembly according to claim 6, wherein the locking element is coupled to an end region of the stem part, away from the sliding part, and is inclined in the direction of the longitudinal gap as viewed from the operating position of the suspension element, and wherein the locking element tapers starting from the stem part.

21. The trailing cable assembly according to claim 2, further comprising an axle at an end region of the stem part and oriented transversely to the longitudinal dimension of the stem part, and wherein the sliding part is configured to tilt about the axle in a direction that is away from the holding part.

22. The trailing cable assembly according to claim 12, wherein the power cable is configured as a flat cable with a plurality of electrical wires.

23. The trailing cable assembly according to claim 22, wherein the rail comprises a generally C-shaped cross section arranged with the longitudinal gap pointing downwards and the hollow space of the rail broadening out from the longitudinal gap.
